(19) United States
(12) Patent Application Publication
(10) Pub. No.: US 2023/0272944 A1
(43) Pub. Date: Aug. 31, 2023

(54) FRAME FOR A LIQUID THROUGHFLOWABLE 3D-FABRIC AND ASSEMBLY OF SUCH A FRAME AND FABRIC

(71) Applicant: VIRIDI HOLDING B.V., Hengelo (NL)

(72) Inventor: Nicolaas Johannes VISSER, Nijkerk (NL)

(73) Assignee: VIRIDI HOLDING B.V., Hengelo (NL)

(21) Appl. No.: 17/766,714

(22) PCT Filed: Oct. 13, 2020
(86) PCT No.: PCT/NL2020/050628

§ 371 Date: Apr. 5, 2022

(30) Foreign Application Priority Data
Oct. 18, 2019 (NL) 2024045

(51) Int. Cl. F24S 10/80; F24S 80/40; F24S 80/30; H02S 40/44

(52) U.S. Cl. CPC F24S 10/80; F24S 80/40; F24S 80/30; H02S 40/44

(57) ABSTRACT

A frame for a liquid-throughflowable 3D fabric includes two first frame parts lying opposite each other, where each first frame part is configured to lie against at least a first part of a peripheral edge of the 3D fabric and to close the fabric at least substantially liquid-tightly along the first part of the peripheral edge. An assembly with such a frame and liquid-throughflowable 3D fabric, where the first parts of the peripheral edge of the 3D fabric are closed at least substantially liquid-tightly by the frame. A 3D fabric includes two main surfaces which are connected to each other along at least a part of the peripheral edge of the 3D fabric.

The invention relates to a frame for a liquid-throughflowable 3D fabric.

Such a frame can be used to attach a 3D fabric to a solar panel, for instance against a rear side thereof. A liquid can then flow through the 3D fabric, whereby heat transfer can take place from the solar panel to the liquid, or vice versa.

According to the invention, the frame comprises two first frame parts lying opposite each other, wherein each first frame part is configured to lie against at least a first part of a peripheral edge of the 3D fabric and to close the fabric at least substantially liquid-tightly along the first part of the peripheral edge.

Such a frame has the advantage that it can be used to close a 3D fabric which does not take a liquid-tight form along its whole peripheral edge liquid-tightly. The 3D fabric can hereby form together with the frame a substantially closed space through which liquid can flow, substantially without leaking. One or more liquid inlets and/or outlets are possibly arranged for this purpose.

It is preferred to use a liquid, such as water, to flow through the 3D fabric, because liquids are able to absorb a relatively large amount of heat. Instead of a liquid, use can optionally also be made of a suitable gas. Embodiments of the invention in which the liquid is replaced by a gas are therefore also deemed to be part of the invention and are deemed to be covered by the appended claims. Where reference is made in this application to liquid-tight, this can therefore alternatively be understood to mean fluid-tight.

In an embodiment of the frame according to the invention the frame further comprises two second frame parts which lie opposite each other and are configured to lie against at least a second part of the peripheral edge of the 3D fabric and to close the fabric substantially liquid-tightly along the second part of the peripheral edge, wherein the second frame parts extend substantially at right angles to the first frame parts on either side of the first frame parts, such that the first and second frame parts together define a substantially closed frame for receiving the 3D fabric such that at least a peripheral edge of the 3D fabric is closed at least substantially liquid-tightly by the frame.

Such a closed frame can be used to make a 3D fabric which is not closed along its peripheral edge liquid-tight. Such a 3D fabric can for instance consist of two mutually separated main surfaces of fabric which extend substantially parallel to each other and are connected to each other by a plurality of pile threads. Such a 3D fabric can be woven or knitted integrally, wherein the main surfaces and the pile threads are woven or knitted simultaneously. The frame according to the invention can serve to close the 3D fabric along its peripheral edge, for instance by being connected in liquid-tight manner to both main surfaces.

A closed frame can be understood to mean that the frame defines an all-around, endless framework which can thereby preferably cover the whole peripheral edge of the 3D fabric.

The frame as described above can consist of one whole, for instance one integrally formed part, or can be constructed from individual frame elements. One, several or all individual frame elements are optionally connected to each other.

Lying against the 3D fabric can be understood to mean that no or hardly any space is left between an edge of the 3D fabric and the corresponding frame part, whereby liquid and/or fluid cannot be situated between the two. The first and/or second frame parts can lie directly or indirectly against the 3D fabric.

In another embodiment of the frame according to the invention the first frame parts define a hollow space through which liquid can flow, and are provided on a side which is configured to be directed toward the 3D fabric with a partition wall with at least one opening for the purpose of supplying liquid to or discharging liquid from the 3D fabric.

Liquid can flow from the frame parts into the 3D fabric, or vice versa, through the openings in the partition wall of the first frame parts, which facilitates supplying and discharging of liquid. By arranging the openings in the first frame parts, and because the first frame parts are disposed opposite each other, i.e. on either side of the 3D fabric, a flow of liquid can result via the openings through substantially the whole 3D fabric, from the one first frame part to the other. The 3D fabric can lie, directly or indirectly, against the partition wall. The 3D fabric lying directly against the partition wall provides the advantage that the openings connect directly to the 3D fabric.

The at least one opening can further have the advantage that the position at which liquid enters the 3D fabric can be chosen by positioning of the opening.

In yet another embodiment of the frame according to the invention the partition wall comprises more than one above stated at least one opening, which are arranged distributed over the length of the partition wall.

Distributing the openings over the length of the partition wall enables liquid to be supplied to the 3D fabric and/or to be discharged therefrom along the length of the partition wall. This creates a better distribution of the liquid flow through the 3D fabric, which can improve heat absorption and/or heat generation of the 3D fabric. The hollow space of the respective first frame part can additionally or furthermore serve as supply conduit through which liquid flows so as to be distributed over the 3D fabric in the longitudinal direction of that frame part.

In yet another embodiment of the frame according to the invention the at least one opening is substantially elongate, wherein a longitudinal direction of the at least one elongate opening is parallel to a longitudinal direction of the first frame parts.

The elongate form of the holes can result in a liquid distribution which is favourable for the distribution of liquid in the 3D fabric. With a number of elongate openings it is also possible to achieve a relatively high liquid flow rate with a relatively small number of openings.

In a practical embodiment of the frame according to the invention the frame comprises four corner pieces, wherein a corner piece is in each case disposed between a first frame part and an adjacent second frame part, and is connected thereto.

In yet another embodiment of the frame according to the invention at least one of the four corner pieces comprises a liquid inlet and at least one other of the four corner pieces a liquid outlet, wherein the one corner piece is connected for liquid throughflow to the hollow space of one of the two first frame parts and the other corner piece is connected for liquid throughflow to the hollow space of the other first frame part.

By providing inlets and outlets in the corner pieces, and connecting them for throughflow to the first frame parts, liquid can be supplied to the 3D fabric via the first frame parts. A frame according to this method can allow a simple design of the frame parts. The corner points can also be particularly strong positions for attaching supply and discharge conduits, whereby the placing of the inlet and outlet in the corner pieces can be advantageous. In yet another embodiment of the frame according to the invention each corner piece comprises two connection insertion ends which can be introduced into a or the hollow space of respectively the first and second frame parts.

Such a frame can be assembled in relatively simple manner and/or be relatively strong and/or be given a liquid-tight form in simple manner.

The connection insertion ends particularly form together with the respective frame parts into which they are inserted a substantially closed chamber for adhesive with two or more openings. During assembly, the chamber for adhesive can be filled with adhesive via one opening until adhesive flows from the other openings, so that a sufficient supply of adhesive can be guaranteed in simple manner.

In yet another embodiment of the frame according to the invention one of the two connection insertion ends takes a hollow form, has an open outer end and is connected for liquid throughflow to the liquid inlet or outlet.

In such a frame the liquid inlet or outlet is connected for throughflow to the hollow space of the frame part into which the at least one connection insertion end is inserted. Liquid can thereby flow from the inlet, through the connection insertion end into the hollow space in order to be carried into the 3D fabric, or conversely in opposite direction from the 3D fabric to the liquid outlet.

The other of the two connection insertion ends can for instance be solid or closed at any desired location, so that this connection insertion end is not throughflowable. The liquid inlet or outlet can thereby be connected via only one connection insertion end to only one frame part.

In yet another embodiment of the frame according to the invention the first and optionally the second frame parts and, if provided, the corner pieces each have a flange extending therefrom transversely of the longitudinal direction of the respective frame part or corner piece, and each extending over a part of and parallel to one main surface of the 3D fabric when the 3D fabric is arranged in the frame.

Frame parts with a flange make it simpler to attach the 3D fabric to the frame, and thereby to attach the 3D fabric to for instance a solar panel. In addition, the flange can contribute to making the peripheral edge of the 3D fabric liquid-tight. The flange can particularly be used for applying thereto an adhesive or mastic layer, whereby a liquid-tight connection can be obtained between the frame and the 3D fabric.

The flange can extend beyond the partition wall so that, when the partition wall lies against a 3D fabric, the flange extends over or along a part of the 3D fabric.

Each frame part and/or corner piece particularly has only one flange, which extends over only one main surface of the 3D fabric. The other main surface of the 3D fabric is thereby left clear by the frame parts and/or corner pieces.

The flange is particularly arranged on one longitudinal end of the first and/or second frame parts, wherein the one longitudinal end is the longitudinal end situated closest to the liquid inlet or outlet of at least one of the corner pieces.

Such a frame can be used to attach a 3D fabric against the rear side of a solar panel. The frame and the panel can then be attached such that the longitudinal end of the frame parts and/or corner pieces are directed with the flange away from the panel. The 3D fabric can thereby be placed between the flange and the panel. In this way it is possible in relatively simple manner to obtain a strong connection between the panel and 3D fabric, which can alternatively or additionally be made liquid-tight in relatively simple manner with for instance adhesive or mastic. Because the inlet and outlet are directed away from the panel in this embodiment, just as the flange, sufficient space is created for supply and discharge conduits which can be connected to the inlet and/or outlet.

Without referring to optional corner pieces, the position of the flange can be defined as being at the longitudinal end of a corresponding frame part, which longitudinal end is situated on a side of a 3D fabric contact zone lying opposite a solar panel contact zone. The flange hereby lies removed from the solar panel when the frame is connected to a solar panel, whereby the 3D fabric can be received at least partially between the flange and the panel. It could thus be stated that the flange, the respective frame part and the solar panel thus together define a receiving space for the 3D fabric.

The invention also relates to an assembly of a frame as described above and a liquid-throughflowable 3D fabric, wherein the first parts of the peripheral edge of the 3D fabric are closed at least substantially liquid-tightly by the frame.

Such an assembly can be arranged on a solar panel, for instance on a rear side thereof, for instance in order to cool the solar panel. The 3D fabric serves here for the transfer of heat from the solar panel to the liquid which can flow through the 3D fabric, and the frame serves to close the 3D fabric substantially liquid-tightly and to arrange the 3D fabric relatively firmly on the solar panel.

The frame of the assembly according to the invention can have the above stated features, each individually or in any suitable combination, and can therefore provide the associated advantages.

The frame parts of the assembly particularly lie against the first part of the peripheral wall of the 3D fabric. They are preferably adhered thereto.

In an embodiment of the assembly according to the invention a second, remaining part of the peripheral edge of the 3D fabric is closed liquid-tightly.

The peripheral edge can comprise a plurality of mutually separated second parts along which the peripheral edge of the 3D fabric is closed liquid-tightly.

Because the first frame parts close a first part of the peripheral edge and the other part of the peripheral edge of the 3D fabric is also closed, a closed space through which the liquid can flow is created inside the 3D fabric.

Liquid can be supplied through the first frame parts to the 3D fabric, for instance by placing a corner piece as described above at each end of the first frame parts, wherein each corner piece of course requires only one insertion end, since it need not be connected to second frame parts. Such a corner piece can therefore for instance be referred to as a stopper or closure for an end of the first frame part. Possibly arranged on one or both of the closures of a first frame part is a passage which can be connected to a supply or discharge of liquid.

When the 3D fabric has two main surfaces, these can be connected to each other along the second, remaining part of the peripheral edge, particularly in liquid-tight manner. This can achieve that the 3D fabric is closed along the second, remaining part of the peripheral edge. The connection between the main surfaces can be brought about by means of adhesive, one or more clamps, ultrasonic welding or another suitable way of connecting. The main surfaces can also be connected integrally to each other.

In an embodiment of the assembly according to the invention the at least one opening is arranged in a height direction perpendicularly of the longitudinal direction of the respective frame part at a position which corresponds substantially with a central main plane of the 3D fabric. The central main plane of the fabric can be defined here as an imaginary plane which extends parallel to two main surfaces of the 3D fabric and is situated midway therebetween.

By placing the at least one opening at this position the opening is aligned with the central main plane of the 3D fabric. Liquid which is supplied to the 3D fabric can hereby enter the 3D fabric in relatively simple manner, since the flow resistance of liquid through the 3D fabric is relatively low close to the central main plane.

A height dimension of the at least one opening, defined in a or the height direction perpendicularly of the longitudinal direction of the respective frame part, is particularly smaller than a height dimension of an area of the 3D fabric through which liquid can flow, for instance more than 20% smaller, more preferably more than 40% smaller, most preferably about 50% smaller.

Because the height dimension of the at least one opening is smaller than the height dimension of the throughflowable area, a greater tolerance results for inaccuracies in the placing of the 3D fabric relative to the frame. Due to the use of adhesive or mastic it is difficult to prevent such inaccuracies. The greater tolerance can thereby contribute to reducing the chances of a leak as a result of such an inaccuracy.

In another embodiment of the assembly according to the invention the 3D fabric comprises two main surfaces, wherein at least one main surface is liquid-tight. This relates particularly to the main surface situated on the side of the liquid inlet and outlet, i.e. the side directed away from the solar panel.

The liquid-tight main surface can contribute to a throughflowable space from which no liquid can exit other than via the outlet. The other main surface of the 3D fabric can for this purpose also take a liquid-tight form. An alternative is to arrange the 3D fabric with a main surface which is not liquid-tight on the solar panel, whereby the main surface is made liquid-tight by the solar panel.

The main surfaces can for instance be made liquid-tight by means of an additional (outer) layer, such as a sealing layer of for instance adhesive or silicone. If adhesive and/or silicone is used, it is possible for this layer to have penetrated partially into the fabric layers of the 3D fabric.

In yet another embodiment of the assembly according to the invention, wherein the frame has the above stated flange, each flange extends over a part of one main surface of the 3D fabric, preferably over the liquid-tight main surface.

As described above, a strong and/or liquid-tight connection between frame and 3D fabric can thus be obtained.

The frame and the 3D fabric are particularly adhered to each other in the area of the flange, for instance by means of a silicone adhesive. The silicone adhesive can be used to obtain a strong and/or liquid-tight connection between frame and 3D fabric.

In the assembly according to the invention the 3D fabric can lie against the first and second frame parts so that the frame parts can close at least a part of the peripheral edge of the 3D fabric.

The invention also relates to a 3D fabric, for instance for use in an assembly as described above, comprising two main surfaces which are connected to each other along at least a part of the peripheral edge of the 3D fabric. The main surfaces can be connected to each other as described above, i.e. by adhesion, one or more clamps, ultrasonic welding, or the main surfaces can be connected integrally to each other.

The invention will be further elucidated hereinbelow with reference to the accompanying figures, in which:

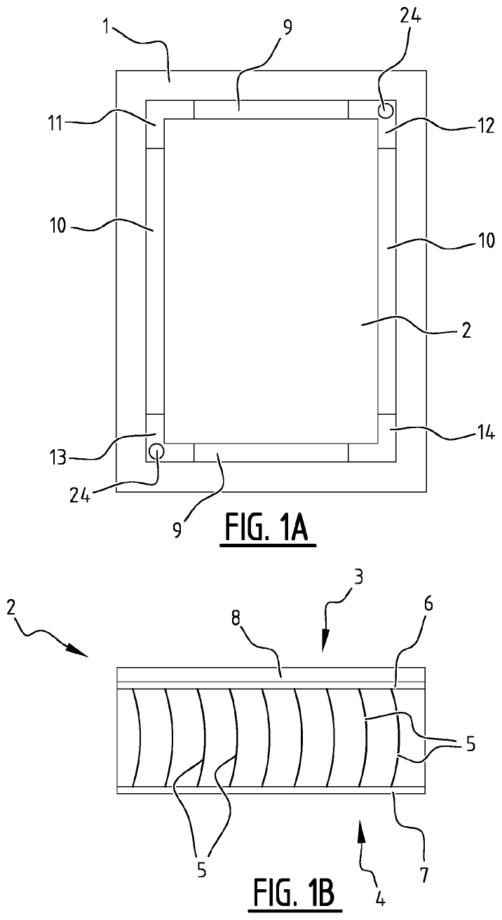

FIG. 1A shows the rear side of a solar panel to which an embodiment of an assembly according to the invention is attached;

FIG. 1B shows a cross-section of the 3D fabric of FIG. 1A;

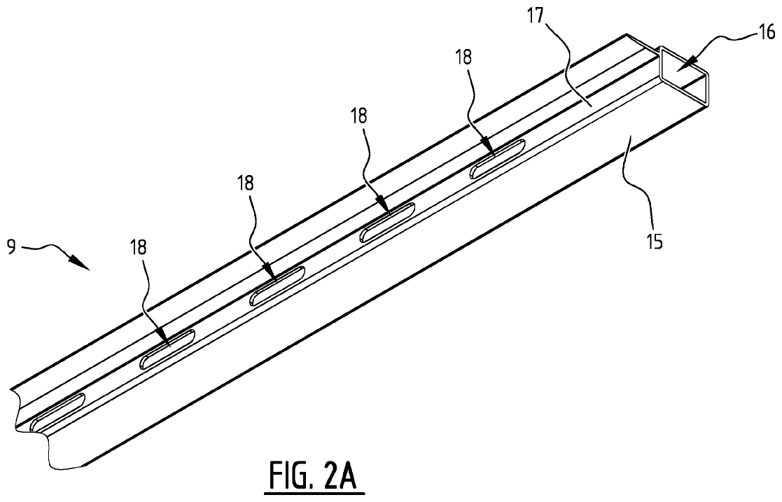

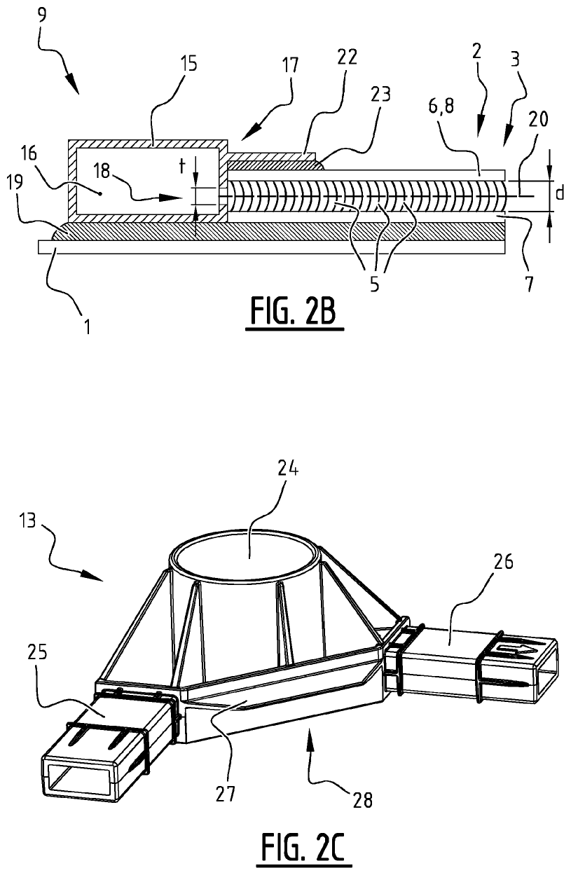

FIG. 2A shows a perspective view of a frame part according to an embodiment of the frame according to the invention;

FIG. 2B shows a cross-section of the frame part of FIG. 2A;

FIG. 2C shows a perspective view of a corner piece according to the embodiment of the frame of FIG. 2A;

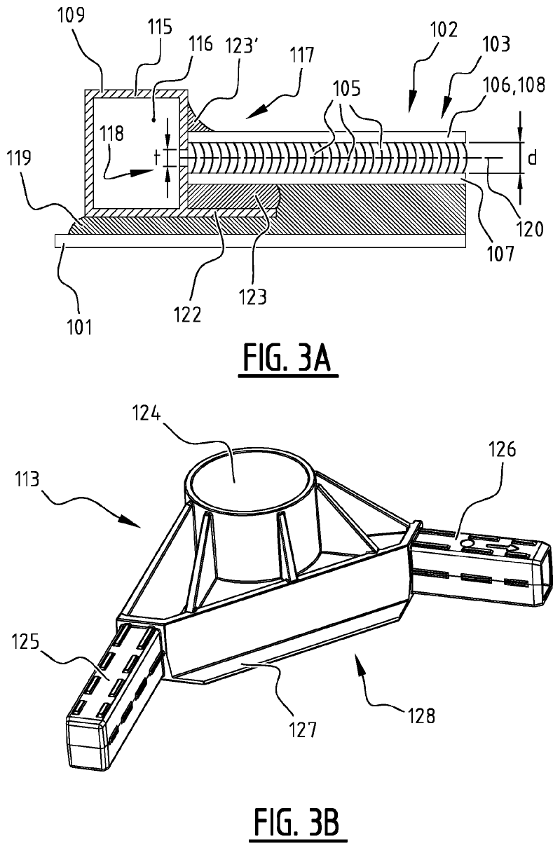

FIG. 3A shows a cross-sectional view of a frame part according to another embodiment of the invention;

FIG. 3B shows a perspective view of a corner piece according to the embodiment of the frame of FIG. 3A;

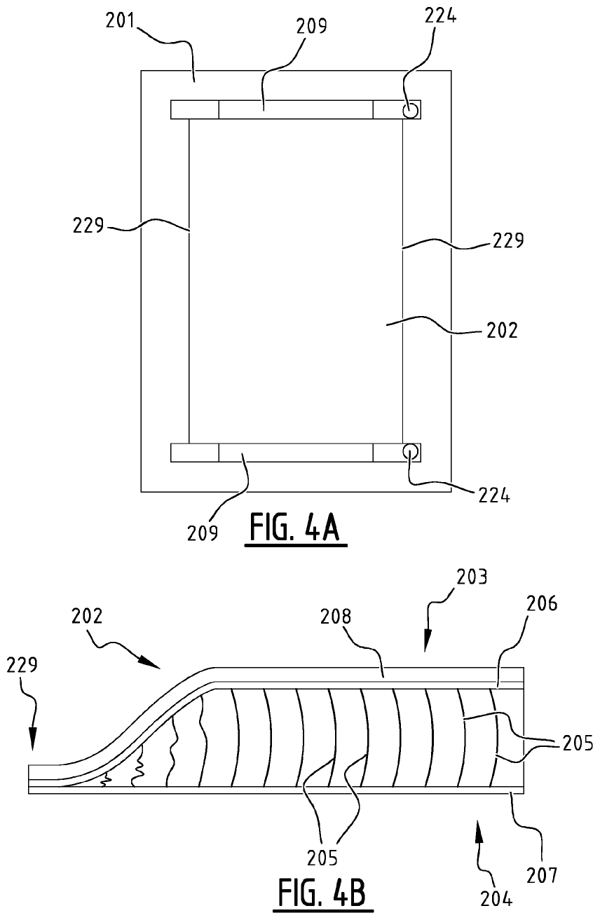

FIG. 4A shows the rear side of a solar panel to which another embodiment of an assembly according to the invention is attached; and

FIG. 4B shows a cross-section of an embodiment of a 3D fabric according to the invention.

The same elements are designated in the figures with the same reference numerals. Corresponding elements of different embodiments are designated with a reference numeral increased by 100 (one hundred).

FIG. 1A shows a rear side of a solar panel 1. Attached to the rear side is a 3D fabric 2. FIG. 1B shows a cross-section of the 3D fabric 2, wherein it is visible that the 3D fabric has two main surfaces 3, 4 which extend parallel to each other, are separated from each other and are connected to each other by a number of pile threads 5. Each main surface 3, 4 has a fabric layer 6, 7. Fabric layers 6, 7 can be woven or knitted simultaneously, wherein pile threads 5 can also be woven or knitted simultaneously. The main surface 3 shown at the top in FIG. 1B is provided with a silicone sealing layer 8. It would have also been possible to apply a liquid-tight sealing layer of another material, or a liquid-tight coating. The silicone of sealing layer 8 in this case penetrates into the fabric layer 6 of the respective main surface 3, which achieves that the main surface is liquid-tight. The other main surface 4 with fabric layer 7 is not liquid-tight here per se, but may be so in a different embodiment. Leaking of the 3D fabric is however prevented when the 3D fabric is placed with this fabric layer 7 against a solar panel 1. The solar panel then provides for a liquid-tight main surface 4 of 3D fabric 2. Referring once again to FIG. 1A, it can be seen that the 3D fabric 2 is connected by means of a frame 9, 10, 11, 12, 13, 14 to solar panel 1. Frame 9, 10, 11, 12, 13, 14 consists of two first frame parts 9 which are disposed opposite each other on either side of the 3D fabric 2. Frame 9, 10, 11, 12, 13, 14 further has two second frame parts 10 which are also disposed opposite each other on either side of the first frame parts 9 and extend substantially perpendicularly relative to first frame parts 9. Each of the frame parts 9, 10 lies against a part of a peripheral edge of 3D fabric 2 and closes it liquid-tightly. The frame parts 9, 10 are always connected to adjoining corner pieces 11, 12, 13, 14 so that a substantially closed frame 9, 10, 11, 12, 13, 14 is defined.

FIG. 2A shows a perspective view of a first frame part 9. First frame part 9 comprises a tubular profile 15, in this case with a rectangular cross-section. Tubular profile 15 defines a throughflowable hollow space 16. A wall 17 of the profile which is configured to be directed toward 3D fabric 2 is provided with a number of openings 18. Liquid can flow from hollow space 16 to 3D fabric 2, or vice versa, through the openings 18. Openings 18 are elongate, and their longitudinal direction runs parallel to the longitudinal direction of profile 15.

First frame part 9 is described further with reference to FIG. 2B. In the cross-section of FIG. 2B an upper side of a solar panel 1 is shown with the frame part 9 and a 3D fabric 2 thereon. The liquid-tight main surface 3 of the 3D fabric is here shown as a single layer 6, 8 for the sake of simplicity. The 3D fabric 2 of FIG. 2B can however be composed as that of FIG. 1B. Applied to solar panel 1 is an adhesive layer 19 whereby both frame 9, 10, 11, 12, 13, 14 and 3D fabric 2 are attached. In this figure it is visible that the openings 18 are disposed at a height position in first frame part 9 which corresponds with a central main plane 20 of the 3D fabric. The height dimension t of the openings 18 is also smaller than a height dimension d of the throughflowable portion of the 3D fabric, in this case about 50% smaller. First frame part 9 is further provided with a flange 22 which extends transversely of the longitudinal direction of the first frame part 9, away from this frame part 9. Flange 22 is configured to extend along at least a part of a main surface 3 of 3D fabric 2, in this case the liquid-tight main surface 3. It is visible in FIG. 2B that the 3D fabric 2 is disposed between flange 22 and solar panel 1. A connection between flange 22 and the 3D fabric is further sealed by means of a mastic layer 23. The main surface 4 of the 3D fabric, which is not liquid-tight, lies against solar panel 1 and is sealed thereby. The 3D fabric, with the exception of the connections to the first frame parts 9, is thereby also closed.

FIG. 2C shows a corner piece 13 whereby a first frame part 9 and a second frame part 10 can be connected to each other. Corner piece 13 has a passage 24 which can function as liquid inlet or as liquid outlet. Corner piece 13 further has two connection insertion ends 25, 26. In order to bring about a connection to a first frame part 9 and second frame part 10 the connection insertion ends 25, 26 are inserted into the hollow spaces 16 of respectively first frame part 9 and second frame part 10. The connection insertion end 26 which is connected to first frame part 9 takes a hollow form, has an open outer end and is connected for throughflow to passage 24. This creates a throughflow path from passage 24, through corner piece 13 to the hollow space 16 of first frame part 9. Corner piece 13 further has a flange 27 which has a function corresponding to that of the flange 22 of first frame part 9. Passage 24 is directed away from an underside 28 of the corner piece. The underside 28 is configured to lie against a solar panel 1. Optional conduits which are connected to passage 24 thus run away from corner piece 13 of the solar panel. Flange 27 is arranged at a distance from the underside 28 of corner piece 13. This distance creates a space in which the 3D fabric 2 can be received, between flange 27 and solar panel 1. In a mutually connected state of corner piece 13 and frame parts 9, 10 the flanges 22 of frame parts 9, 10 are situated at a longitudinal end of the frame parts which is situated closest to passage 24, and thereby at a distance from a solar panel 1 when frame 9, 10, 11, 12, 13, 14 is arranged thereon.

FIG. 1A shows how two corner pieces 12, 13 which are situated diagonally opposite each other are provided with a passage 24. This results in use in a uniform distribution of flow through 3D fabric 2. It is also possible to provide each corner piece 11, 12, 13, 14 with a passage. It is then possible during installation on for instance a roof of the frame 9, 10, 11, 12, 13, 14 to choose which corner pieces 11, 12, 13, 14 will be connected to supply and discharge conduits and which corner pieces 11, 12, 13, 14 will be capped. It is however not necessary to provide every corner piece 11, 12, 13, 14 with a passage 24. Instead, it suffices to provide each first frame part 9 with one corner piece 12, 13 having a passage 24. The other corner piece 11, 14 of that frame part can then largely correspond with the above described corner pieces 12, 13, and differ therefrom only in that the other corner pieces 11, 14 have no passage 24 or a sealed passage 24. It is particularly possible to opt to provide two corner pieces 12, 13 which lie diagonally opposite each other with a passage 24 and not to provide the other two corner pieces 11, 14, which then also lie diagonally opposite each other, with a passage 24.

Unless stated otherwise, the second frame parts 10 are the same as the above described first frame part 9. It is however possible to omit the openings 18 here.

FIGS. 3A and 3B show, in views corresponding with respectively FIGS. 2B and 2C, another variant of the first frame part 109 and corner piece 113 according to the invention. The variant of FIGS. 3A and 3B is the same as the one mentioned above, unless stated otherwise. In both corner piece 113 and first frame part 109 the flange 122, 127 has been placed toward the underside 128 relative to the position of the flange 22, 27 in the variant of FIGS. 2A-2C. Flange 122, 127 can hereby be arranged between 3D fabric 102 and solar panel 101 as shown in FIG. 3A. 3D fabric 102 is here connected to frame part 2 with an additional mastic layer 123′. Instead of a mastic layer 123′, it is also possible to use an adhesive layer. Similar mastic layers can optionally be provided at corner pieces 113.

It is further also noted here that, although only one corner piece 13, 113 has been described, the other corner pieces can take a similar form. It is also possible to provide two corner pieces 12, 13, 113 which are connected to the different first frame parts with a passage 24, 124, and two other corner pieces 10, 11 not, as shown in FIG. 1A. It will be apparent that for corner piece 12 the connection insertion ends 26, 25 must then be switched with each other so that the passage 24 of corner piece 12 is connected for throughflow to first frame part 9.

Just as FIG. 1A, FIG. 4A shows a solar panel 201 with an assembly according to the invention. Mounted on the solar panel is a 3D fabric, a cross-section of which is shown in FIG. 4B. The 3D fabric 202 differs from the above described 3D fabric 2, 102 only in that the two main surfaces 203, 204 of the 3D fabric are mutually connected along an edge 229 of the 3D fabric. In this case the main surfaces 203, 204 are connected to each other liquid-tightly. In the example shown in the figure use is made of ultrasonic welding, although it is also possible to opt for another suitable connecting method such as adhesion, clamping or an integral connection. The frame of FIG. 4A has no second frame parts along the edges 229 where the main surfaces 203, 204 of the 3D fabric are connected to each other. The frame comprises only first frame parts 209 on two mutually opposite edges of 3D fabric 202 which are not connected to each other. The first frame parts 209 form together with the mutually connected main surfaces 203, 204 a closed, throughflowable space inside the 3D fabric 202. The first frame parts 209 are each provided at one end with a passage 224 through which liquid can be supplied to or discharged from first frame part 209. It is of course also possible to arrange the passage 224 at both ends of a frame part 209, or at another longitudinal position of the first frame part 209.

Although the invention is elucidated above on the basis of a number of specific examples and embodiments, the invention is not limited thereto. The invention instead also covers the subject-matter defined by the following claims.

1. A frame for a liquid-throughflowable 3D fabric, comprising:
two first frame parts lying opposite each other,
wherein each first frame part is configured to lie against at least a first part of a peripheral edge of the 3D fabric and to close the fabric at least substantially liquid-tightly along the first part of the peripheral edge.

2. The frame according to claim 1, further comprising:
two second frame parts which lie opposite each other and are configured to lie against at least a second part of the peripheral edge of the 3D fabric and to close the fabric substantially liquid-tightly along the second part of the peripheral edge,
wherein the second frame parts extend substantially at right angles to the first frame parts on either side of the first frame parts, such that the first and second frame parts together define a substantially closed frame for receiving the 3D fabric such that at least a peripheral edge of the 3D fabric is closed at least substantially liquid-tightly by the frame.

3. The frame according to claim 1, wherein the first frame parts define a hollow space through which liquid can flow and are provided on a side which is configured to be directed toward the 3D fabric with a partition wall with at least one opening for the purpose of supplying liquid to or discharging liquid from the 3D fabric via the at least one opening.

4. The frame according to claim 3, wherein the partition wall comprises more than one above stated at least one opening, which are arranged distributed over the length of the partition wall.

5. The frame according to claim 3, wherein the at least one opening is substantially elongate, wherein a longitudinal direction of the at least one elongate opening is parallel to a longitudinal direction of the first frame parts.

6. The frame according to claim 2, further comprising four corner pieces, wherein a corner piece is in each case disposed between a first frame part and an adjacent second frame part, and is connected thereto.

7. The frame according to claim 3, further comprising four corner pieces, wherein a corner piece is in each case disposed between a first frame part and an adjacent second frame part, and is connected thereto, wherein at least one of the four corner pieces comprises a liquid inlet and at least one other of the four corner pieces comprises a liquid outlet, and wherein the one corner piece is connected for liquid throughflow to the hollow space of one of the two first frame parts and the other corner piece is connected for liquid throughflow to the hollow space of the other first frame part.

8. The frame according to claim 6, wherein each corner piece comprises two connection insertion ends which can be introduced into a or the hollow space of respectively the first and second frame parts.

9. The frame according to claim 7, wherein each corner piece comprises two connection insertion ends which can be introduced into a or the hollow space of respectively the first and second frame parts, and wherein one of the two connection insertion ends takes a hollow form, has an open outer end and is connected for liquid throughflow to the liquid inlet or outlet.

10. The frame according to claim 1, wherein the first and optionally the second frame parts and, if provided, the corner pieces each have one flange, each extending therefrom transversely of the longitudinal direction of the respective frame part or corner piece, and each extending over a part of and parallel to one main surface of the 3D fabric when the 3D fabric is arranged in the frame.

11. The frame according to claim 6, wherein each corner piece comprises two connection insertion ends which can be introduced into a or the hollow space of respectively the first and second frame parts, wherein one of the two connection insertion ends takes a hollow form, has an open outer end and is connected for liquid throughflow to the liquid inlet or outlet, and wherein the flange is arranged on one longitudinal end of the first and/or second frame parts, wherein the one longitudinal end is the longitudinal end situated closest to the liquid inlet or outlet of at least one of the corner pieces.

12. An assembly of a frame according to claim 1 and a liquid-throughflowable 3D fabric, wherein the first parts of the peripheral edge of the 3D fabric are closed at least substantially liquid-tightly by the frame.

13. The assembly according to claim 12, as dependent on one of the claim 1 or 3-11, wherein a second, remaining part of the peripheral edge of the 3D fabric is closed liquid-tightly.

14. The assembly according to claim 13, wherein the 3D fabric has two main surfaces which are connected to each other along the second, remaining part of the peripheral edge.

15. The assembly according to claim 12, as dependent on at least claim 3, wherein a midpoint of the at least one opening lies substantially halfway between the main surfaces of the 3D fabric in a height direction perpendicularly of the longitudinal direction of the respective frame part.

16. The assembly according to claim 12, as dependent on at least claim 3, wherein a height dimension of the at least one opening, defined in a or the height direction perpendicularly of the longitudinal direction of the respective frame part, is smaller than a height dimension of an area of the 3D fabric through which liquid can flow, for instance more than 20% smaller, more preferably more than 40% smaller, most preferably about 50% smaller.

17. The assembly according to claim 12, wherein the 3D fabric comprises two main surfaces, wherein at least one main surface is liquid-tight.

18. The assembly according to claim 12, wherein a frame according to claim 10 or 11 is provided, wherein each flange extends over a part of one main surface of the 3D fabric, preferably over the liquid-tight main surface.

19. The assembly according to claim 18, wherein the frame and the 3D fabric are adhered to each other in the area of the flange, for instance by means of a silicone adhesive.

20. A 3D fabric for use in an assembly according to claim 12, comprising two main surfaces which are connected to each other along at least a part of the peripheral edge of the 3D fabric.
